(19) United States
(12) Patent Application Publication
(10) Pub. No.: US 2017/0098465 A1
(43) Pub. Date: Apr. 6, 2017

(54) METHOD AND APPARATUS FOR AUTOMATED SHAPING OF MULTIMEDIA CONTENT

(71) Applicant: INTERNATIONAL BUSINESS MACHINES CORPORATION, Armonk, NY (US)

(72) Inventors: ALEXEI KARVE, Mohegan Lake, NY (US); CLIFFORD A. PICKOVER, YORKTOWN HEIGHTS, NY (US); ANCA SAILER, YORKTOWN HEIGHTS, NY (US)

(21) Appl. No.: 14/876,493

(22) Filed: Oct. 6, 2015

(51) Int. Cl. G11B 27/036; G09B 5/06; H04N 21/81; H04N 21/442; H04N 21/462

(52) U.S. Cl. CPC G11B 27/036; H04N 21/44218; H04N 21/462; H04N 21/812; G09B 5/065

(57) ABSTRACT

Methods and systems for shaping content include determining a degree of compression for a piece of content, using a processor, based on a user's cognitive state and a set of temporal circumstances. The piece of content is modified to constrain its play time in accordance with the degree of compression.

### BACKGROUND

Technical Field

The present invention relates to presenting multimedia content and, more particularly, to shaping multimedia content to accommodate a user's needs.

Description of the Related Art

While many people enjoy consuming various media, including movies, educational lectures, books, email, and magazines, the time that they can spend on such activities is often limited. Furthermore, people enter various cognitive states, such as fatigue, alertness, sadness, and happiness, which may shape their viewing needs and desires along with their ability to assimilate different kinds of content.

### SUMMARY

A method for shaping content includes determining a degree of compression for a piece of content, using a processor, based on a user's cognitive state and a set of temporal circumstances. The piece of content is modified to constrain its play time in accordance with the degree of compression.

A method for shaping content includes determining a degree of compression for a piece of content, using a processor, based on a user's cognitive state and a set of temporal circumstances that include a run-time of the piece of content and time constraints imposed by the user's schedule. The piece of content is modified to constrain its play time in accordance with the degree of compression by deleting portions of the content to make the modified piece of content fit within the time constraints.

A system for shaping content includes a processor configured to determine a degree of compression for a piece of content based on a user's cognitive state and a set of temporal circumstances. A content shaping module is configured to modify the piece of content to constrain its play time in accordance with the degree of compression.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a block/flow diagram of a method of content shaping in accordance with the present principles;

FIG. 2 is a block/flow diagram of content scheduling in accordance with the present principles;

FIG. 3 is a block diagram of a system for shaping content in accordance with the present principles;

FIG. 4 is a diagram of a cloud computing environment according to the present principles; and

FIG. 5 is a diagram of abstraction model layers according to the present principles.

### DETAILED DESCRIPTION

Embodiments of the present invention provide the ability to shape multimedia content—altering the content itself—based on information about the user's needs and cognitive state. This shaping may include the deletion of content (e.g., to make a movie fit into an allotted time slot), speeding up content, providing a synopsis of deleted content, etc. The present embodiments may also estimate a user's cognitive state responsive to, e.g., calendar information and/or biometric sensing.

While the present embodiments are discussed herein with a particular focus on visual media such as movies and television shows, it should be understood that any form of media may be shaped according to the present principles. These forms of media include, but are not limited to, movies, television shows, online streaming content, books, magazines, emails, educational content, classroom lectures, technical journals, etc.

The media content is shaped according to circumstances and the user's state. In one example, a user's calendar is analyzed to determine that the user may be, for example, stressed from many meetings during the day. Alternatively, if a particular holiday is approaching, the media may be shaped to emphasize, or at least to preserve, themes and content relating to the holiday.

In considering the user's cognitive state, cognitive characteristics may include, e.g., user demographics, age, interests, cognitive impairments, emotional considerations, etc. Determination of the user's cognitive state may be based on any appropriate method, including, for example, a user or group profile, biometric monitoring of a user's response to content, a parent's or caregiver's settings, etc. The biometric monitoring may include monitoring the user's medical vitals for e.g., high blood pressure, or may alternatively monitor subtler and non-invasive forms of biometric information. The user's medical profile may include baseline vital information, psychological factors (such as responsiveness to violent imagery), and existing medical conditions. Other information related to the user's cognitive state may include weather and temperature information and self-reported or data-mined mood information from, e.g., social networks.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

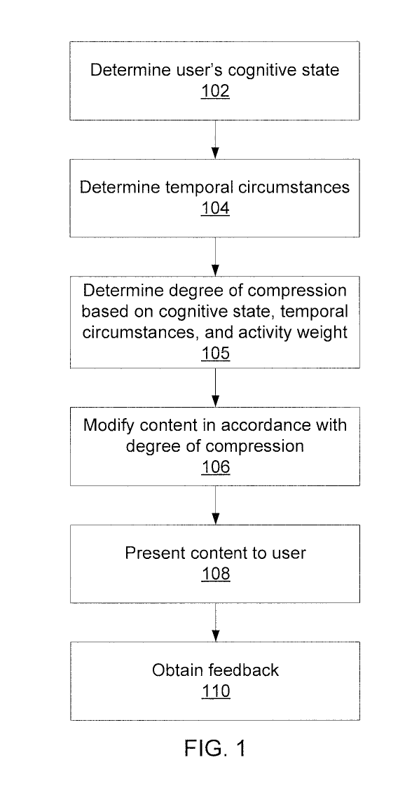

Referring now to FIG. 1, a method of shaping content is shown. While a user is engaged with a piece of content (e.g., audiovisual content, textual content, etc.), block 102 determines the user's cognitive state. This may be accomplished by any appropriate technique, as described above. Block 104 determines the user's temporal circumstances. These circumstances may include the time of day, the user's schedule (based on reference to the user's calendar to determine an amount of time available to consume the media), and circumstances within the content (e.g., running time, time elapsed, time to a reasonable stopping point, etc.).

Block 105 determines a degree of compression for the content to be shaped. A function is used to translate the user's cognitive state and the temporal circumstances, weighted by an importance value, into a degree of compression. In one example, if the user's cognitive state is measured as fatigue on a scale of 0 to 1 and an amount of available time is one hour for a piece of content that is one and a half hours long, the block 105 determines a running time for the shaped content. Following this example, a higher fatigue level or shorter available time may lead to a higher degree of compression, while a lower fatigue or longer available time may lead to less compression. Any appropriate function may be used, tailored to the types of data available.

The weight used in block 105 may represent how important the content in question is. For example, if a particular piece of content is particularly dense in information or is required viewing for a class or other instructional purpose, then the weight value may reflect this and will result in a lower amount of compression. Conversely, if the weight value is low, then a greater amount of compression may be used because the content is relatively unimportant.

In one embodiment, degree of compression may simply be multiplied by the weight value. For example, if the piece of content is deemed to be critical for the user, the weight value may be set equal to zero, such that the content will not be compressed at all, regardless of what degree of compression is computed. On the other hand, if the content is not important, then the value may be set to a high value, such as, e.g., 0.9. It is contemplated that any appropriate weighting scale may be used.

It should be understood that, although the term “degree of compression” is used throughout the present disclosure, it is explicitly contemplated that this “degree of compression” may in fact result in shaping content to produce an output that is longer than the original. For example, modifying the content may include adding scenes, in addition to simply deleting them. As such, in some circumstances the degree of compression may be, e.g., a factor greater than 1, such that the total run time of the shaped content is extended.

Block 106 modifies the content in accordance with the user's cognitive state and temporal circumstances, expressed as the degree of compression. Content alteration may include, e.g., the deletion of scenes to make a movie fit into an allotted time slot, the speeding of certain scenes, the provision of a synopsis of deleted scenes, the removal of sensitive content, etc. It is particularly contemplated that the content may be changed in response to the user's cognitive and temporal needs. For example, if a user is accessing a piece of content late at night, the user may be fatigued and less alert, and complicated or slow-paced material may be omitted. If the ambient noise level increases or if the user is hard of hearing, the volume may be increased and subtitles may be turned on. The content may also be altered based on previous correlations between scenes and medical information among people. For example, if the user has a high risk of heart disease, and a known correlation exists between blood pressure and a particular scene, block 106 may delete that scene to protect the user. In the context of a lecture or other educational material, block 106 may skip or summarize material that the user has already mastered. In the context of a potentially stressful scene, the scene may be muted or otherwise altered or blocked.

Of particular note, in content that may have multiple different paths or endings, block 106 may affirmatively select one of the possible presentations. For example, a given movie may have a happy ending alternative and a darker ending alternative. Based on the user's cognitive state, block 106 may choose one or the other as being more likely to be enjoyed. Similarly, the content may be have been edited to remove scenes that were not likely to be appreciated by all audiences, and block 106 may reintroduce these scenes if it is determined that the user's cognitive state would be receptive.

In another embodiment, block 106 may act to censor content. Certain types of content and language may not be appropriate for all audiences. If a person's cognitive state (which may include the person's age) indicates that particular content is not suitable for them, then that material may be removed. This decision may draw information from disparate sources, including social media profiles and other sources where the user may establish their personal preferences.

Block 106 may also be used to inject product placement into content based on a user's brand preferences. This may be used to insert objects and brand logos at specific points based on the user's preferences. For example, if the user's profile indicates that the user drinks soda, soda-related brands may be inserted into the content.

Block 106 may further change a level of intensity of the content by including or omitting particular scenes. One specific example would be in the case of horror movies, where the perceived horror level may be adjusted based on the audience. A device takes a picture of the audience, tagging the picture with facial recognition and calculating a confidence score for the overall horror level of the audience. Each person has a perceived horror level based on the number and rating of previous horror movies they have watched. The overall horror level may then be calculated by, e.g., sum of the horror movies seen by the audience, raised to log(10+N−1), where N is the number of people tagged in the picture. This formula gives a higher acceptable horror level for a larger audience or for an audience that has watched many horror movies.

The alteration in block 106 may furthermore be used to introduce a quick recap or history segment to help a user remember the context or previous appearance of certain characters or plot points. This may include, for example, an interlude showing earlier scenes or may include an overlay on the content in the form of text or images to help provide contextual information. Similarly, for lectures or other educational material, content may be automatically reviewed before advancing to more advanced topics.

Block 108 then presents the modified content to the user. Block 110 obtains feedback from the user regarding how the altered content affected the user's cognitive state. This feedback may be self-reported by the user or may alternatively be directly ascertained using one or more biometric sensors.

As noted above, block 106 may provide a summary of altered or omitted audiovisual or textual content. The summary can depend on the duration of the summarized segment, a preference for a length of the summary, the type of content (e.g., live broadcast versus replay from storage), genre, and personalized user profile information. The full summary of the program, if available, may be employed to generate a summary for the altered portion. Alternatively, automatic video and speech analysis, together with analysis of subtitles or ancillary information sources (if available) may be employed to automatically generate the summary. It is particularly contemplated that content providers may provide scene-by-scene summaries that are provided with the content itself in anticipation of those scenes being skipped, for example in the form of a commentary for the movie and cut scenes.

Another application of the present principles includes fostering active learning in users. Educational content can be tailored according to a user's moods and needs. In addition, active learning fosters cognitive dissonance and self-questioning on the part of the student. Tasks are prioritized to the needs of the student, drawing on knowledge from what the student has previously seen, how long ago, and what topics other students have deemed important. Content from other sources can also be inserted, such that content on similar or related topics from other sources can be used to clarify certain details. Block 106 can link to such external sites to enable the student to quickly access the information in question and proceed back to the main task.

The insertion of material can also take the role of “plugin content,” which is content created by, for example, a parent in their own voice, that enhances the content. A child watching the content may or may not need to know that some content was skipped or updated. In another embodiment, there may be snippets of movies modified by different authors that are more entertaining, or better at explaining some concepts, than the original content. Such plugin content would specify which content it replaces in the original. If there are sufficient votes (e.g., the feedback of block 110) for the plugin content, then when the user watches the original content, the scenes may automatically be replaced with plugin content to enhance the viewer's experience.

In a further embodiment, the feedback of block 110 may be used to directly shape the content in response to a user's real-time input. One example of this would be in “choose your own adventure” content, where the user is presented with a set of choices and specific content is selected in accordance with those choices.

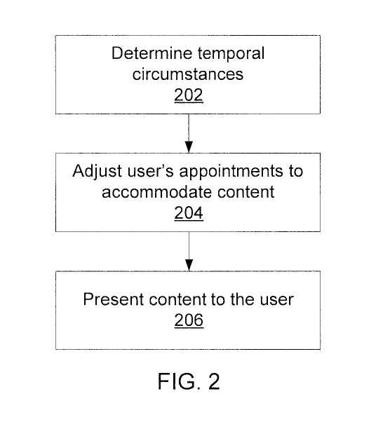

Referring now to FIG. 2, a method for tailoring a user's calendar to accommodate a piece of content is shown. Block 202 determines the user's temporal circumstances. As above, this may include the time of day, the user's schedule (based on reference to the user's calendar to determine an amount of time available to consume the media), and circumstances within the content (e.g., running time, time elapsed, time to a reasonable stopping point, etc.).

Block 204 adjusts the user's appointments to accommodate the content. For example, if a user is watching a piece of content that is expected to run longer than an available time block, and the user has a relatively unimportant meeting scheduled before the content would end, block 204 may reschedule the meeting to a more convenient time. Block 206 then displays the content to the user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

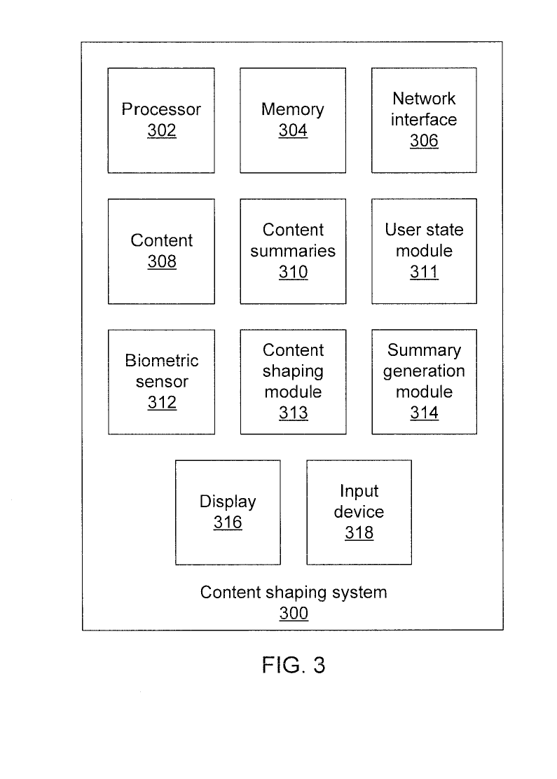

Referring now to FIG. 3, a content shaping system 300 is shown. The system 300 includes a hardware processor 302 and memory 304. A network interface 306 optionally provides connection to a content provider either through a wired or wireless network and may be a bi-directional interface, supporting the transmission of information to the provider as well as reception, or a unidirectional interface that simply receives broadcast information. It should be noted that the system 300 may include one or more additional modules. These modules may be implemented as software running on the hardware processor 302 or may be implemented in discrete hardware units such as, e.g., an application specific integrated chip or a field programmable gate array.

Content 308 is stored in the memory 304 and may be received on-demand from the network interface 306 or may be obtained locally through a physical storage medium. Content summaries 310 may be obtained along with the content 308 from a storage medium or the network interface 306 or may and may be stored in memory 304. Alternatively, the content summaries 310 may be automatically generated by a summary generation module 314 which uses the processor 302 to analyze the content 308 and to determine a textual summary for scenes in the content that may be altered or deleted.

A user state module 311 uses information determined by, e.g., one or more biometric sensors 312 to determine the user's cognitive state. In addition, the user state module 311 may access other information, such as calendar information stored in the memory 304 or a profile of the user stored in the memory 304 to make a determination regarding the user's overall state. Content shaping module 313 uses the processor 302 to alter the content 308 in accordance with the user's cognitive and overall states. As described above, this may include the deletion or modification of one or more portions of the content 308 and may furthermore include replacing or augmenting such scenes with content summaries 310.

A display 316 is used to display the shaped content 308 and may include a graphical display for the display of graphical or textual content. The display 316 may also include speakers or other forms of output for content that is expressed in other media. An input device 318 allows the user to control the content playback and to provide settings and information that is stored in the memory 304 and that may be used to determine how the content shaping module 313 alters the content 308.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

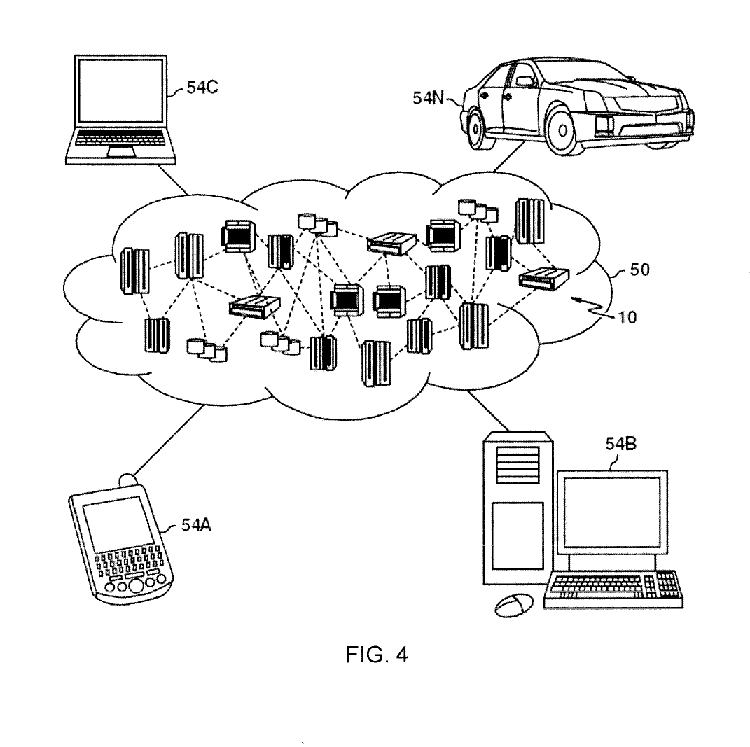

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

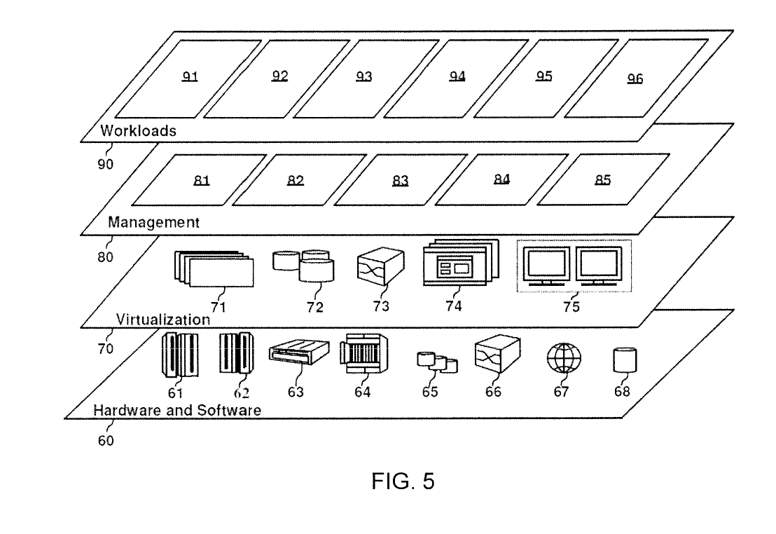

Referring now to FIG. 5, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and content shaping 96.

Having described preferred embodiments of automated shaping of multimedia content (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for shaping content, comprising:
determining a degree of compression for a piece of content, using a processor, based on a user's cognitive state and a set of temporal circumstances; and
modifying the piece of content to constrain its play time in accordance with the degree of compression.

2. The method of claim 1, wherein modifying the piece of content comprises deleting portions of the piece of content.

3. The method of claim 2, wherein modifying the piece of content comprises inserting a synopsis of a deleted portion of the piece of content.

4. The method of claim 2, wherein a deleted portion of the piece of content comprises sensitive material that is contraindicated by the user's cognitive state or medical condition.

5. The method of claim 2, wherein the piece of content is educational material and a deleted portion of the piece of content covers material that the user has already mastered.

6. The method of claim 1, wherein modifying the piece of content comprises inserting material into the piece of content.

7. The method of claim 6, wherein inserting material into the piece of content comprises inserting product placement.

8. The method of claim 6, wherein inserting material into the piece of content comprises inserting previously edited or deleted scenes.

9. The method of claim 6, wherein inserting material into the piece of content comprises inserting a history segment or recap of material from a previous piece of content.

10. The method of claim 1, further comprising determining at least one temporal circumstance by accessing the user's calendar information to determine timing information for scheduled events.

11. A non-transitory computer readable storage medium comprising a computer readable program for shaping content, wherein the computer readable program when executed on a computer causes the computer to perform the steps of claim 1.

12. A method for shaping content, comprising:
determining a degree of compression for a piece of content, using a processor, based on a user's cognitive state and a set of temporal circumstances that include a run-time of the piece of content and time constraints imposed by the user's schedule; and
modifying the piece of content to constrain its play time in accordance with the degree of compression by deleting portions of the content to make the modified piece of content fit within the time constraints.

13. A system for shaping content, comprising:
a processor configured to determine a degree of compression for a piece of content based on a user's cognitive state and a set of temporal circumstances; and
a content shaping module configured to modify the piece of content to constrain its play time in accordance with the degree of compression.

14. The system of claim 13, wherein the content shaping module is further configured to delete portions of the piece of content.

15. The system of claim 14, wherein the content shaping module is further configured to insert a synopsis of a deleted portion of the piece of content.

16. The system of claim 14, wherein a deleted portion of the piece of content comprises sensitive material that is contraindicated by the user's cognitive state or medical condition.

17. The system of claim 14, wherein the piece of content is educational material and a deleted portion of the piece of content covers material that the user has already mastered.

18. The system of claim 13, wherein the content shaping module is further configured to insert material into the piece of content.

19. The system of claim 18, wherein the content shaping module is further configured to insert product placement.

20. The system of claim 18, wherein the content shaping module is further configured to insert previously edited or deleted scenes.
